(19) United States
(12) Patent Application Publication
(10) Pub. No.: US 2016/0005190 A1
(43) Pub. Date: Jan. 7, 2016

(54) Image Processing Method for Transparent Display System

(71) Applicant: Chunghwa Picture Tubes, Ltd., Taoyuan (TW)

(72) Inventors: Pei-Lin Hsieh, Hsinchu City (TW); Hsiang-Tan Lin, Keelung City (TW)

(21) Appl. No.: 14/461,435

(22) Filed: Aug. 17, 2014

(30) Foreign Application Priority Data
Jul. 1, 2014 (TW) 103122714

(51) Int. Cl. G06T 11/00; G09G 5/02; G06T 5/00

(52) U.S. Cl. CPC G06T 11/001; G06T 5/00; G06T 5/003; G09G 5/02

(57) ABSTRACT

An image processing method of a transparent display system includes providing the transparent display system, where the transparent display system includes an image processor and a transparent display panel. The image processor receives an input image. The image processor enhances the chroma of the image according to a predetermined weighting value to produce an enhanced chroma image. The image processor sharpens the contour of the image to produce a sharpened image data. The image processor adds the enhanced chroma image to the sharpened image data to produce an adjusted image. The transparent display panel displays the adjusted image.

### BACKGROUND OF THE INVENTION

1. Field of the Invention

The present invention illustrates an image processing method, and more particularly, the image processing method having the capability of increasing the image recognition and transparency of the transparent display system.

2. Description of the Prior Art

With the advancement of technology, various display panels are developed to satisfy the requirements of users. The conventional display panels are non-transparent display panels. The key idea is to use the light emitting component in the display panel for displaying image. However, since the conventional display panels are non-transparent and have no light penetrability, the objects behind the conventional display panels are sheltered by the display panels.

To present objects behind the display panels, a transparent display panel is developed. The main difference between the transparent display panel and the conventional display panel is that the transparent display panel can not only display images by using the ambient light, but also have light penetrability. Since the transparent display panels have light penetrability, the objects behind the conventional display panels are visible. However, since there is no stable light emitting component in the transparent display panel, the contours of the displayed images are blurred. Further, when the transparent display panel displays the images, the light penetrability of the transparent display panel becomes worse. As a result, the objects behind the transparent display panel cannot be presented clearly.

According to the above issues, the display performance of the transparent display panel and the recognition of the presented objects behind the transparent display panel are degraded based on light penetrability. Thus, it is important to propose the transparent display panel having the capability for increasing the image recognition and transparency so as to clearly present the objects behind the transparent display panel.

### SUMMARY OF THE INVENTION

In an embodiment of the present invention, an image processing method for a transparent display system is disclosed. The method includes providing the transparent display system comprising an image processor and a transparent display panel. The image processor receives an input image. The image processor enhances chroma of the input image according to a predetermined weighting value to produce an enhanced chroma image. The image processor sharpens contour of the input image to produce a sharpened image data. The image processor adds the enhanced chroma image to the sharpened image data to produce an adjusted image. The transparent display panel displays the adjusted image.

In another embodiment of the present invention, a transparent display system is disclosed. The transparent display system includes an image processor and a transparent display panel. The image processor is used for receiving an input image, enhancing the chroma of the input image according to a predetermined weighting value to produce an enhanced chroma image, sharpening a contour of the input image to produce a sharpened image data, adding the enhanced chroma image to the sharpened image data to produce an adjusted image. The transparent display panel is coupled to the image processor for displaying the adjusted image.

Compared with the conventional image processing method, the image processing method for the transparent display system in the present invention can increase the image recognition and the light penetrability when the transparent display system displays the image. Thus, the transparent display system not only displays the image clearly on the display panel but also presents the objections clearly behind the transparent display system.

### BRIEF DESCRIPTION OF THE DRAWINGS

FIG. 1 is a schematic block diagram of transparent display system according to the embodiment of the present invention.

FIG. 2 illustrates the image processing method of transparent display system in FIG. 1 according to the first embodiment of the present invention.

FIG. 3 illustrates the image processing method of transparent display system in FIG. 1 according to the second embodiment of the present invention.

FIG. 4 illustrates a first method to improve light penetrability according to the embodiment in FIG. 3.

FIG. 5 illustrates a second method to improve light penetrability according to the embodiment in FIG. 3.

FIG. 6 illustrates the image processing method of transparent display system in FIG. 1 according to the third embodiment of the present invention.

FIG. 7 is the flowchart of the image processing method of transparent display system according to the embodiment in FIG. 3.

FIG. 8 is the flowchart of the image processing method of transparent display system according to the embodiment in FIG. 6.

### DETAILED DESCRIPTION

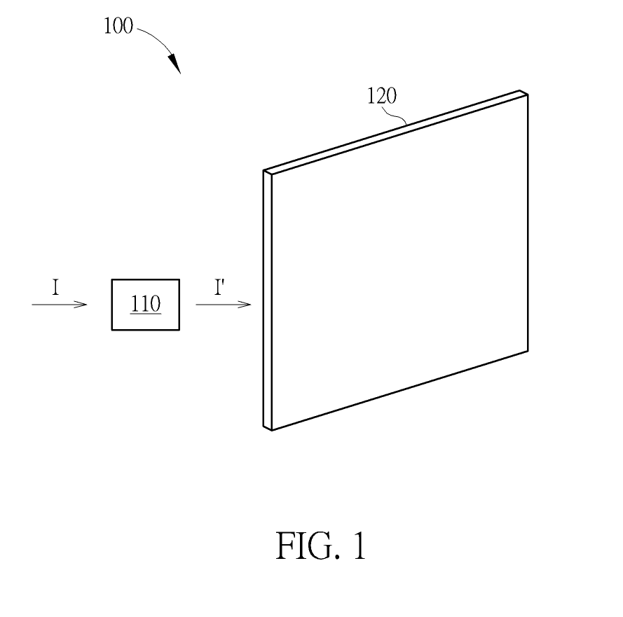

FIG. 1 is a schematic block diagram of transparent display system 100 according to an embodiment of the present invention. As shown in FIG. 1, a transparent display system 100 includes an image processor 110 and a transparent display panel 120. The image processor 110 is used for receiving an input image I and then processing the input image I. The transparent display panel 120 is coupled to the image processor 110 for displaying the adjusted image I′, wherein the adjusted image I′ is outputted from the image processor 110. In the present invention, the transparent display system 100 uses the image processor 110 to perform image processing of the input image I. When the transparent display panel 120 displays the adjusted image I′, the transparent display panel 120 displays a high quality image in conjunction with high light penetrability (i.e., transparency). The steps of image processor 110 processing the input image I to the adjusted image I′ are expressed below.

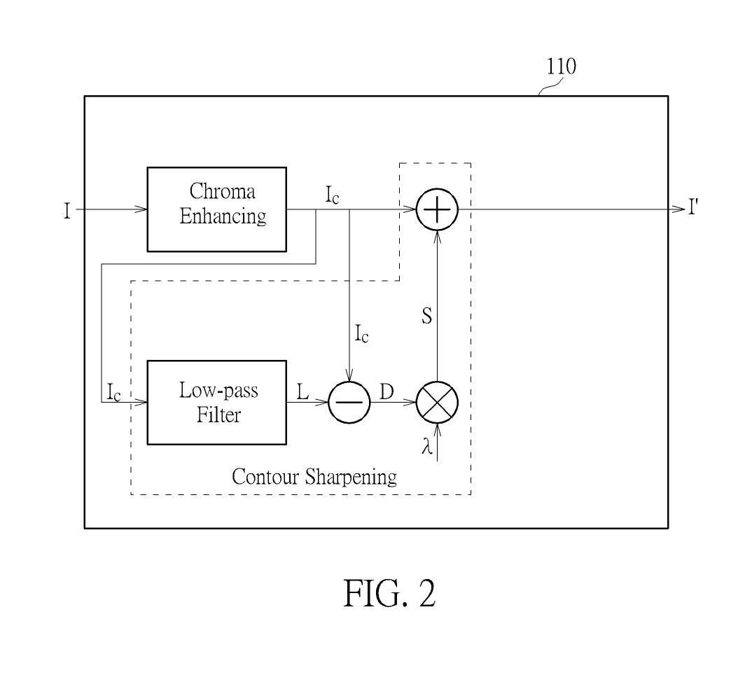

FIG. 2 illustrates the image processing method of transparent display system 100 in FIG. 1 according to the first embodiment of the present invention. As shown in FIG. 2, when the image processor 110 receives the input image I, the image processor 110 firstly processes the input image I by a chroma enhancement process to produce an enhanced chroma image Ic. According to the image processing theory, the sense of layering of the image is increased when at least one of the saturation of the image, hue of the image, and chroma of the image is enhanced. Although the sense of layering of the image is increased, the edge of the image and the highlight/shadow part of the image suffer from unavoidable distortion since the dynamic range of the image is reduced. To mitigate this distortion, a sharpening process (i.e., image contour sharpening) is applied to the enhanced chroma image Ic for compensating the distortion of the edge of the image caused by enhancing the chroma of the image. The image process for enhancing the chroma and sharpening the contour are illustrated below.

When the image processor 110 receives the input image I, the image processor 110 performs a chroma enhancement process. Particularly, the image processor 110 enhances the chroma of the input image I to produce an enhanced chroma image Ic according to a predetermined weighting value. In the embodiment, the image processor 110 evaluates an original chroma of the input image I by invoking an equation. Such equation can be expressed as

Co=1−[min(R,G,B)/max(R,G,B)] (1)

wherein Co denotes the original chroma of the input image I, min(R,G,B) is a minimum value of gray level among red pixels, green pixels, blue pixels of the input image, max(R,G,B) is a maximum value of gray level among red pixels, green pixels, blue pixels of the input image.

After the image processor 110 evaluates the original chroma of the input image I by equation (1), the image processor 110 evaluates the chroma of the input image I to be enhanced according to another equation. Then, the image processor 110 produces an enhanced chroma image Ic. The equation can be written by

Cw=Co+Co*Wc (2)

wherein Cw is the chroma of the input image to be enhanced and Wc denotes the predetermined weighting value. As described above, the sense of layering of the image is increased when the chroma of the image is enhanced, leaving the edge of the image and the highlight/shadow part of the image suffering from unavoidable distortion caused by the reduction of the dynamic range of the image. Thus, in the embodiment, to improve the definition of image without producing severe distortion of the edge of the image and the highlight/shadow part of the image, the predetermined weighting value Wc is appropriately chosen within the value of 0.5 to 3.

The range of the dotted line in FIG. 2 denotes the sharpening process. As shown in FIG. 2, the enhanced chroma image Ic firstly passes through a low-pass filter. Then, the low-frequency image data L can be extracted from the enhanced chroma image Ic. The image processor 110 further subtracts the image data of the enhanced chroma image Ic from the low-frequency image data L to produce an image difference data D. From the point of view of image processing theory, the image difference data D includes the information of image contour. Then, the image processor 110 multiplies the image difference data D by a predetermined multiplier λ to produce the sharpened image data S. Equivalently, this process is to enhance the contour information of the image. Finally, the image processor 110 adds the enhanced chroma image Ic to the sharpened image data S to produce an adjusted image I′. Since the image sharpening process and the image chroma enhancing process is used, the adjusted image I′ presents a fine sense of layering with slight image contour distortion. However, according to the image processing theory, the Halo effect occurs when the image is overly sharpened by the sharpening process (the predetermined multiplier λ is too large). Such overly sharpening process makes the edge of image suffer from severe whitening. Thus, in the embodiment, the predetermined multiplier λ is appropriately chosen within the value of 5 to 10.

In the embodiment of transparent display system 100, although the sharpening process can further enhance some of the information of the contour edge distorted by the chroma enhancing process, according to the information theory, the information of the contour edge cannot be completely recovered because the information loss. Thus, some distortions of the image contour still exist in the adjusted image I′. To solve this problem, the following embodiments are provided to further improve the image quality of the adjusted image I′.

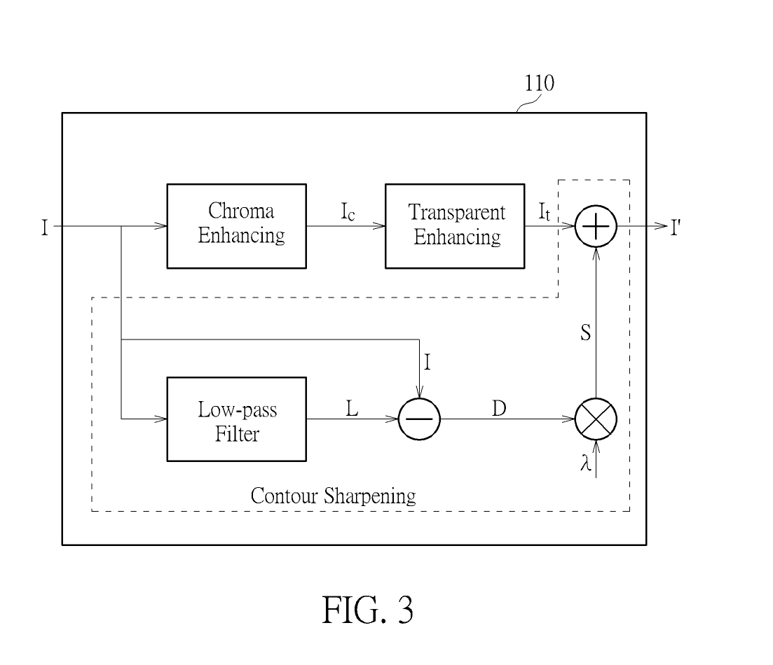

FIG. 3 illustrates the image processing method of transparent display system 100 in FIG. 1 according to the second embodiment of the present invention. As shown in FIG. 3, when the image processor 110 receives the input image I, the image processor 110 firstly processes the input image I by a chroma enhancement process to produce an enhanced chroma image Ic. Then, the enhanced chroma image Ic is processed by a transparency enhancement process. After transparency enhancement processing, the image processor 110 updates the enhanced chroma image Ic according to the processed image outputted by the transparency enhancement process. Here, for presentation convenience, the updated enhanced chroma image Iₜ in FIG. 3 is still called as enhanced chroma image. The transparency enhancement process is described below.

The main difference from the second embodiment in FIG. 3 and the first embodiment is that the sharpening process in FIG. 3 (i.e., the process in the range of dotted line in FIG. 3) is operated on the input image I and the image processor 110 finally adds the enhanced chroma image Iₜ to the sharpened image data S to produce an adjusted image I′. Since the steps of the sharpening process are illustrated in the first embodiment, they are omitted here for presentation briefly. Comparing the step of sharpening process of this embodiment with the first embodiment, this embodiment takes the advantage since the sharpened image data S is extracted from the original input image I. The information of the edge of the original input image I is undistorted so that the distortion of the edge of the sharpened image data S caused by enhancing chroma can be recovered. When the image processor 110 adds the enhanced chroma image Iₜ to the sharpened image data S to produce an adjusted image I′, the adjusted image I′ presents fine sense of layering in conjunction with high recognition and definition since the distortion of the edge of the adjusted image I′ can be maximally recovered. Further, since the transparency enhancement process is used to improve light penetrability, the transparent display system 100 in this embodiment can clearly display the adjusted image I′ and clearly present the objects behind the transparent display system 100 at the same time.

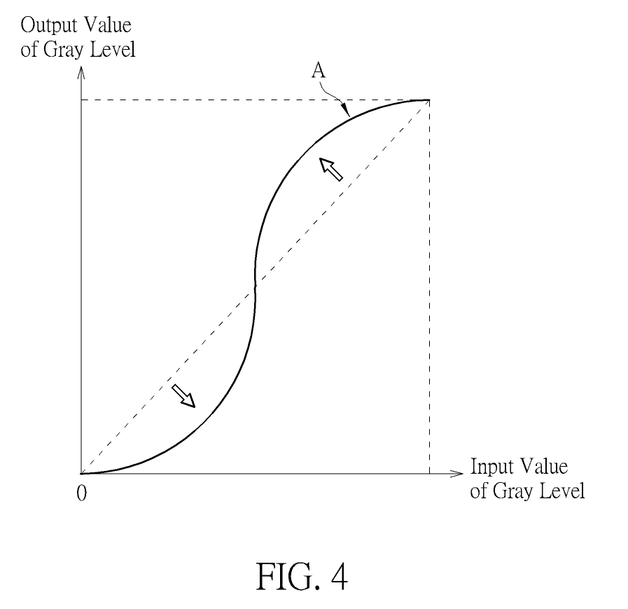

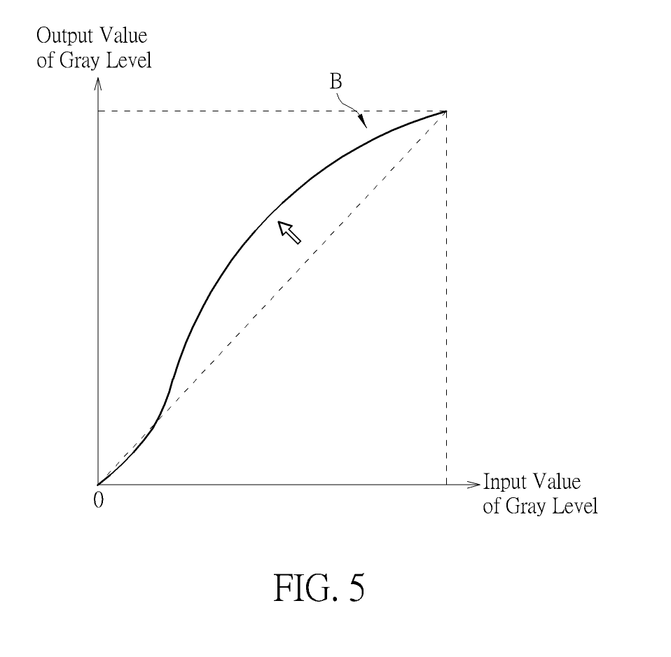

FIG. 4 and FIG. 5 illustrate two methods of the transparency enhancement process to improve light penetrability. In FIG. 4, the coordinate axis of X denotes the input value of gray level. The coordinate axis of Y denotes the output value of gray level. When the correlation between the input value of gray level and the output value of gray level is linear and the line slope is equal to one, the input value of gray level is equal to the output value of gray level. The image is processed without any modification. In the first method for enhancing transparency, the image processor 110 decreases value of gray level of pixels with low value of gray level and/or increases the value of gray level of pixels with high value of gray level of the enhanced chroma image Ic, as the continuous line A in FIG. 4. By doing so, the image contrast with respect to the highlight part and the shadow part of the enhanced chroma image Ic is increased so that the transparency of the transparent display system 100 can be accordingly improved. Such transparency improved method by increasing the contrast of the highlight part and the shadow part of the image is called a vivid mode in the embodiment.

In FIG. 5, the coordinate axis of X denotes the input value of gray level. The coordinate axis of Y denotes the output value of gray level. When the correlation between the input value of gray level and the output value of gray level is linear and the line slope is equal to one, the input value of gray level is equal to the output value of gray level. The image is processed without any modification. In the second method for enhancing transparency, the image processor 110 increases value of gray level of pixels with medium value of gray level and high value of gray level of the enhanced chroma image Ic, as the continuous line B in FIG. 5. By doing so, the light intensity with respect to the medium light part and the highlight part of the enhanced chroma image Ic is increased so that the transparency of the transparent display system 100 can be accordingly improved. Such transparency improved method by increasing the light intensity of the medium light part and the highlight part of the image is called a bright mode herein.

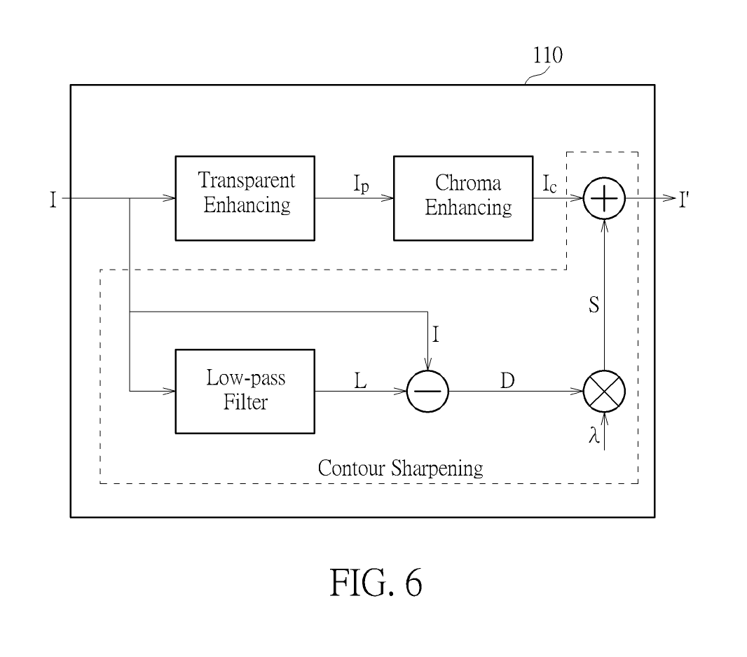

FIG. 6 illustrates the image processing method of transparent display system 100 in FIG. 1 according to the third embodiment of the present invention. The main difference from this embodiment and the second embodiment is that the transparency enhancement process is applied before the chroma enhancement process. The sharpening process in this embodiment is the same as in the second embodiment so that the distortion of the edge of the adjusted image I′ can be completely recovered by the sharpened image data S. Since the transparency enhancement process, the chroma enhancement process, and the sharpening process are illustrated above, they are omitted here for presentation briefly. Like the second embodiment, the transparent display system 100 in this embodiment can clearly display the adjusted image I′ and clearly present the objects behind the transparent display system 100 at the same time.

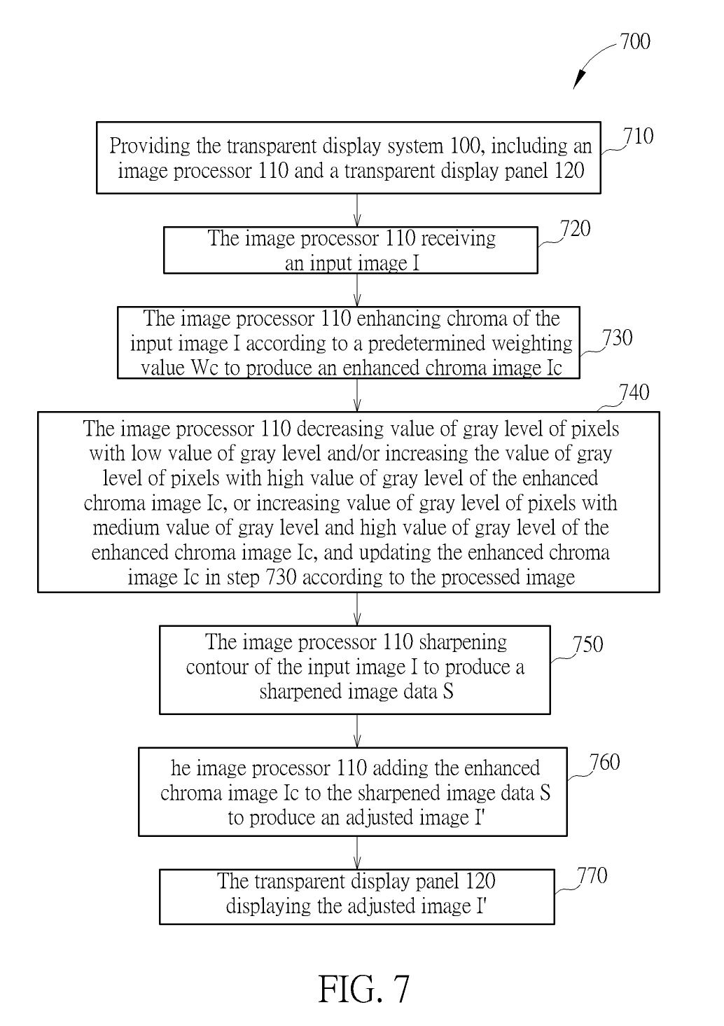

FIG. 7 is the flowchart 700 of the image processing method of transparent display system according to the first embodiment in FIG. 3. As shown in FIG. 7, the first image processing method of the invention includes the following steps, as

Step 710: providing the transparent display system 100, including an image processor 110 and a transparent display panel 120;

Step 720: the image processor 110 receiving an input image I;

Step 730: the image processor 110 enhancing chroma of the input image I according to a predetermined weighting value We to produce an enhanced chroma image Ic;

Step 740: the image processor 110 decreasing value of gray level of pixels with low value of gray level and/or increasing the value of gray level of pixels with high value of gray level of the enhanced chroma image Ic, or increasing value of gray level of pixels with medium value of gray level and high value of gray level of the enhanced chroma image Ic, and updating the enhanced chroma image Ic in step 730 according to the processed image;

Step 750: the image processor 110 sharpening contour of the input image I to produce a sharpened image data S;

Step 760: the image processor 110 adding the enhanced chroma image Ic to the sharpened image data S to produce an adjusted image I′; and

Step 770: the transparent display panel 120 displaying the adjusted image I′.

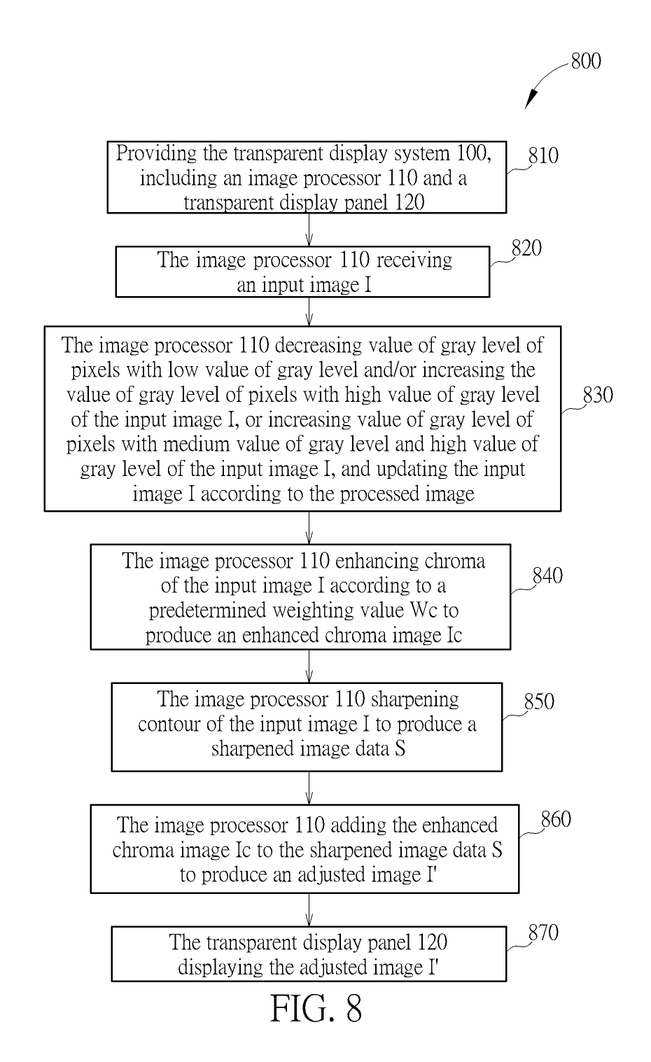

FIG. 8 is the flowchart 800 of the image processing method of transparent display system according to the second embodiment in FIG. 6. As shown in FIG. 8, the second image processing method of the invention includes the following steps, as

Step 810: providing the transparent display system 100, including an image processor 110 and a transparent display panel 120;

Step 820: the image processor 110 receiving an input image I;

Step 830: the image processor 110 decreasing value of gray level of pixels with low value of gray level and/or increasing the value of gray level of pixels with high value of gray level of the input image I, or increasing value of gray level of pixels with medium value of gray level and high value of gray level of the input image I, and updating the input image I according to the processed image;

Step 840: the image processor 110 enhancing chroma of the input image I according to a predetermined weighting value We to produce an enhanced chroma image Ic;

Step 850: the image processor 110 sharpening contour of the input image I to produce a sharpened image data S;

Step 860: the image processor 110 adding the enhanced chroma image Ic to the sharpened image data S to produce an adjusted image I′; and

Step 870: the transparent display panel 120 displaying the adjusted image I′.

To sum up, the present invention illustrates an image processing method and a transparent display system. The key idea of the image processing method is to enhance the chroma of the image and further add the enhanced chroma image to the sharpened image data to produce an image with fine sense of layering and high contour definition. Further, two methods of the transparency enhancement process for improving light penetrability are also used. Thus, the transparent display system of the invention can improve light penetrability to clearly present the objects behind and can improve the definition of displayed image at the same time.

What is claimed is:

1. An image processing method for a transparent display system, the method comprises the following steps:
providing the transparent display system, comprising an image processor and a transparent display panel;
the image processor receiving an input image;
the image processor enhancing chroma of the input image according to a predetermined weighting value to produce an enhanced chroma image;
the image processor sharpening contour of the input image to produce a sharpened image data;
the image processor adding the enhanced chroma image to the sharpened image data to produce an adjusted image; and
the transparent display panel displaying the adjusted image.

2. The method of claim 1, wherein image processor sharpening the contour of the input image to produce the sharpened image data comprises:
filtering an original image data of the input image by a low-pass filter to produce a low-frequency data;
subtracting the original image data of the input image from the low-frequency data to produce an image difference data; and
multiplying the image difference data by a predetermined multiplier to produce the sharpened image data.

3. The method of claim 2, wherein the predetermined multiplier value is constrained within the value of 5 to 10.

4. The method of claim 1, further comprises:
the image processor decreasing value of gray level of pixels with low value of gray level and/or increasing value of gray level of pixels with high value of gray level of the enhanced chroma image to produce a processed image, and updating the enhanced chroma image according to the processed image.

5. The method of claim 4, wherein image processor sharpening the contour of the input image to produce the sharpened image data comprises:
filtering an original image data of the input image by a low-pass filter to produce a low-frequency data;
subtracting the original image data of the input image from the low-frequency data to produce an image difference data; and
multiplying the image difference data by a predetermined multiplier to produce the sharpened image data.

6. The method of claim 5, wherein the predetermined multiplier value is constrained within the value of 5 to 10.

7. The method of claim 1, further comprises:
the image processor increasing value of gray level of pixels with medium value of gray level and high value of gray level of the enhanced chroma image to produce a processed image, and updating the enhanced chroma image according to the processed image.

8. The method of claim 7, wherein image processor sharpening the contour of the input image to produce the sharpened image data comprises:
filtering an original image data of the input image by a low-pass filter to produce a low-frequency data;
subtracting the original image data of the input image from the low-frequency data to produce an image difference data; and
multiplying the image difference data by a predetermined multiplier to produce the sharpened image data.

9. The method of claim 8, wherein the predetermined multiplier value is constrained within the value of 5 to 10.

10. The method of claim 1, further comprises:
the image processor decreasing value of gray level of pixels with low value of gray level and/or increasing value of gray level of pixels with high value of gray level of the input image to produce a processed image, and updating the input image according to the processed image.

11. The method of claim 10, wherein image processor sharpening the contour of the input image to produce the sharpened image data comprises:
filtering an original image data of the input image by a low-pass filter to produce a low-frequency data;
subtracting the original image data of the input image from the low-frequency data to produce an image difference data; and
multiplying the image difference data by a predetermined multiplier to produce the sharpened image data.

12. The method of claim 11, wherein the predetermined multiplier value is constrained within the value of 5 to 10.

13. The method of claim 1, further comprises:
the image processor increasing value of gray level of pixels with medium value of gray level and high value of gray level of the input image to produce a processed image, and updating the input image according to the processed image.

14. The method of claim 13, wherein image processor sharpening the contour of the input image to produce the sharpened image data comprises:
filtering an original image data of the input image by a low-pass filter to produce a low-frequency data;
subtracting the original image data of the input image from the low-frequency data to produce an image difference data; and
multiplying the image difference data by a predetermined multiplier to produce the sharpened image data.

15. The method of claim 14, wherein the predetermined multiplier value is constrained within the value of 5 to 10.

16. The method of claim 1, wherein the image processor enhancing the chroma of the input image according to the predetermined weighting value to produce the chroma enhanced image comprises:
the image processor evaluating an original chroma of the input image, wherein the original chroma is derived by the following equation:
Co=1−[min(R,G,B)/max(R,G,B)],
wherein Co is the original chroma of the input image, min (R, G, B) is a minimum value of gray level among red pixels, green pixels, blue pixels of the input image, max (R,G,B) is a maximum value of gray level among red pixels, green pixels, blue pixels of the input image.

17. The method of claim 16, wherein the image processor enhancing the chroma of the input image according to the predetermined weighting value to produce the enhanced chroma image further comprises:
the image processor multiplying the original chroma of the input image by a summation of one and the predetermined weighting value to produce the enhanced chroma image, wherein the predetermined weighting value is constrained within the value of 0.5 to 3.

18. A transparent display system comprises:
an image processor for receiving an input image, enhancing the chroma of the input image according to a predetermined weighting value to produce an enhanced chroma image, sharpening a contour of the input image to produce a sharpened image data, adding the enhanced chroma image to the sharpened image data to produce an adjusted image; and
a transparent display panel coupled to the image processor for displaying the adjusted image.
